(19) United States
(12) Patent Application Publication
(10) Pub. No.: US 2009/0052443 A1
(43) Pub. Date: Feb. 26, 2009

(54) METHOD AND APPARATUS FOR MANAGING DYNAMIC FILTERS FOR NESTED TRAFFIC FLOWS

(76) Inventors: Santosh Kolenchery, Cary, NC (US); Sumit Garg, Grapevine, TX (US)

Correspondence Address: ERICSSON INC., 6300 LEGACY DRIVE, M/S EVR 1-C-11, PLANO, TX, 75024, US

(21) Appl. No.: 11/843,952

(22) Filed: Aug. 23, 2007

(51) Int. Cl. H04L 12/56

(52) U.S. Cl. 370/389

(57) ABSTRACT

An apparatus and method of creating and managing dynamic filters while permitting stateful inspections of a hierarchy of nested flows in the dataplane. The method determines if a filter qualifier of a packet flowing in the forwarding data-plane matches a first filter rule. If the filter qualifier of the packet matches the first filter rule, a dynamic filter is created. An action or actions associated with the dynamic filter are then executed. Stateful inspections may be accomplished while maintaining a state of a parent flow and any sub-flows. The method may be implemented on firewalls or routers.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to mobile communication systems. More particularly, and not by way of limitation, the invention is directed to an apparatus and method for managing dynamic filters for nested traffic flows.

A classification engine in a data-plane of a router or firewall utilizes an ordered set of filter rules. Each filter rule consists of match conditions and corresponding actions. The match conditions include specific or wildcard matches on layer 3 and layer 4 fields on Internet Protocol (IP) packet headers, as well as additional metadata provided by other blocks in the router/firewall's data-plane. The incoming data packet header is checked against the match conditions in the ordered filter rule set either by a hash lookup or by using a Content Addressable Memory (CAM).

A chain of action blocks associated with a specific filter rule allows an operator to alter packet processing functions, such as rate policing, remarking of IP layer 3 header fields, etc. Each filter action is maintained physically as a block in memory with the identifier of the matching filter, action codes, parameters, counters, and state (in case of stateful inspection). Typically, a packet processing routine in packet processing system associated with the action code is invoked in case of a filter match.

A flow is defined as traffic whose layer 3 and layer 4 fields match specific values or wildcards. Thus “nested flows” imply a set of flows, where one flow is subsumed (i.e. wholly contained) by the other flow to form a hierarchy of flows.

There are existing implementations which handle nested flows by processing actions associated with nested flow by software in the control plane (higher layer software) as opposed to the dataplane. However, software processing in control plane of these existing systems is not easily scaleable under high traffic usage.

Other implementations for handling nested flows utilize multistage classifiers in the dataplane where each stage performs actions on one level of flow at a time. However, multistage classifiers require costly additional hardware. In addition, it is also very difficult to maintain a line rate in the data-plane with multiple classification stages.

Another alternative is to decompose the outer flows into a collection of inner sub-flows and configure one filter for each of them statically. However, if all the sub-flow filters are statically configured, an operator uses up filtering stage resources in terms of CAM entries, etc. This is particularly evident where those sub-flows have no traffic. In addition, this solution also is not easily scaleable in certain scenarios. For example, if it is desired to limit the half-open Transmission Control Protocol (TCP) session to each server in a subnet 11.1.1.*/24, to 500 sessions, the operator must create one static filter rule for each server, e.g., 254 filter rules for the subnet.

It would be advantageous to have an apparatus and method for managing dynamic filters for nested traffic flows in the dataplane and which is easily scaleable without utilizing limited filtering stage resources. The present invention provides such an apparatus and method.

### BRIEF SUMMARY OF THE INVENTION

In one aspect, the present invention is directed to a method of creating and managing dynamic filters while permitting stateful inspections of a hierarchy of nested flows. In the present invention, a new filter action, namely the “created dynamic filter” action is conducted. If the packet flowing in the forwarding data-plane matches the conditions of the first filter rule (which is statically configured). and if this filter rule is configured with the “created dynamic filter” action, then a dynamic filter is created. The “filter qualifier” is a parameter that is used to configure the “created dynamic filter” action. The filter qualifier parameter helps specify the scope of the new dynamic filter that is to be created. An action or actions associated with the dynamic filter are then executed. Stateful inspections may be accomplished while maintaining a state of a parent flow and any sub-flows.

In another aspect, the present invention is directed to an apparatus for creating and managing dynamic filters for packets flowing in a forwarding data-plane. The apparatus may reside in a router, firewall or load balancer. The apparatus determines if a packet matches a first filter rule. If the packet matches the first filter rule, the apparatus creates a dynamic filter. The apparatus then performs any action associated with the first dynamic filter including performing a stateful inspection of the packet.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 is a simplified block diagram of a filtering system having a filtering stage apparatus in a firewall in the preferred embodiment of the present invention:

FIG. 2 is an illustration of a basic structure of filter rules and the corresponding action chains of the filter stage apparatus in the data-plane of the firewall in an exemplary embodiment of the filtering system of the present invention;

FIG. 3 is a simplified diagramming illustrating a resulting hierarchy of nested flows of the exemplary embodiment of the filtering system of FIG. 2;

FIG. 4 illustrates dynamic filters within a parent filter in an exemplary embodiment of the present invention;

FIG. 5 illustrates dynamic filters within a parent filter in a second embodiment; and

FIG. 6 is a flow chart outlining the steps for creating and managing recursive dynamic filters for stateful inspections of a hierarchy of nested flows with a corresponding action chain according to the teachings of the present invention.

### DETAILED DESCRIPTION OF THE INVENTION

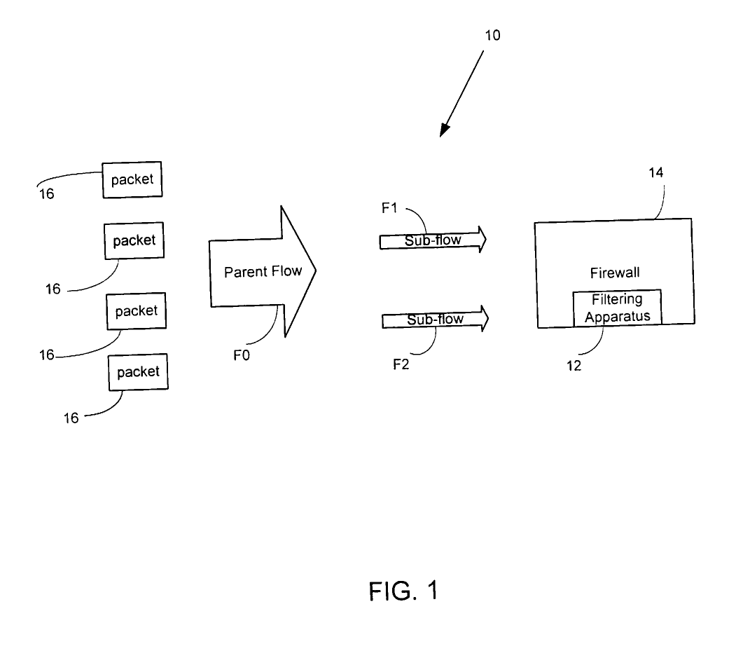

The present invention is an apparatus and method of creating and managing dynamic filters while permitting stateful inspections of a hierarchy of nested flows. FIG. 1 is a simplified block diagram of a filtering system 10 having a filtering stage apparatus 12 in a firewall 14 in the preferred embodiment of the present invention. Although described herein in terms of an embodiment with a firewall, the invention may also be applied to other types of devices utilizing filters such as routers or load-balancers. The filtering stage apparatus provides an algorithm for implementing and managing the dynamic filters for nested traffic flows. Packets 16 flow through a forwarding data-plane, where certain applications such as the firewall 14 are implemented. The firewall application may require that filters match and perform stateful inspection on a hierarchy of nested flows. Some of the filters that match the inner sub-flows may be dynamically created on-demand. The dynamically created filters may be required to apply some stateful/stateless operations on traffic belonging to a parent flow F0 while simultaneously performing other stateful and/or stateless actions on each of a plurality of constituent sub-flows F1 and F2 within the parent flow F0. In addition, the stateful operations on the parent flow F0 (if any) may be dependent on the state of the constituent sub-flows F1 and F2.

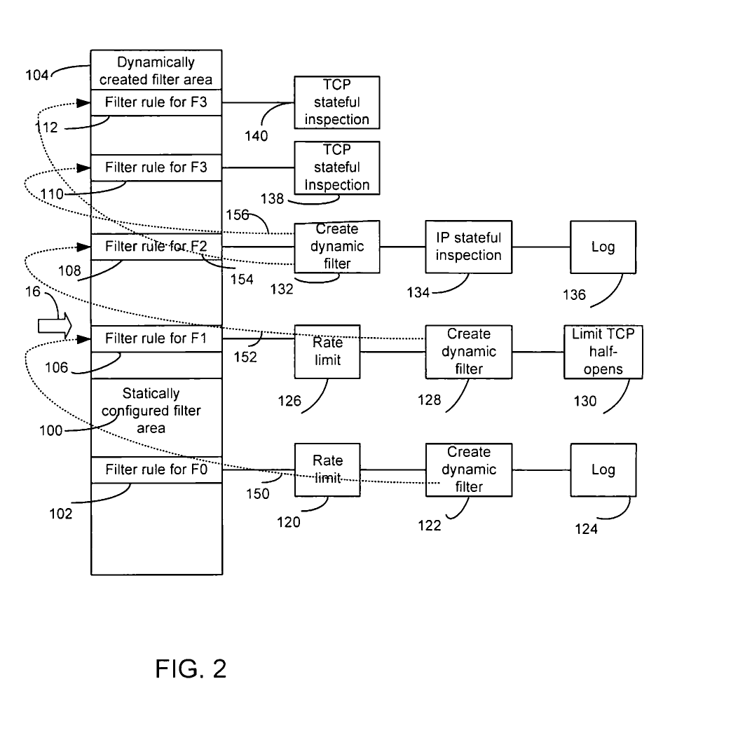

FIG. 2 is an illustration of a basic structure of filter rules and the corresponding action chains of the filter stage apparatus 12 in the data-plane of the firewall 14 in an exemplary embodiment of the filtering system 10 of the present invention. The incoming packet 16 encounters a statically configured filter area 100 having a filter rule 102 for a flow F0. In addition, there is a dynamically created filter area 104 having flows F1, F2, F3, and F3′ with corresponding filter rules 106, 108, 110 and 112 for each flow. The filter rule 102 associated with flow F0 have a match condition based on a Source Address (SA), a Source Port (SP), a Destination Address (DA), and a Destination Port (DP) of (SA=*, SP=*, DA=11.1.1*/24, DP=*). The filter rule 106 associated with flow F1 have a match of (SA=*, SP=*, DA=11.1.1.5, DP=*). The filter rule 108 associated with flow F2 have a match condition of (SA=10.1.1.1, SP=*, DA=11.1.1.5, DP=*). The filter rule 110 associated with flow F3 have a match condition of (SA=10.1.1.1, SP=80, DA=11.1.1.5. DP=80). The filter rule 112 associated with flow F3′ may have a match condition of (SA=10.1.1.1, SP=22, DA=11.1.1.5, DP=22). The match conditions are merely exemplary of possible match conditions implemented with each rule. The F1 is the parent flow of F2, while F3 and F3′ are sub-flows of F2.

In the example illustrated in FIG. 2, the operator desires to rate limit at 120 the traffic for the filter rule 102. After rate limiting at 120, the operator may desire to create a dynamic filter for each unique destination address encountered. For this kind of application, a static filter is configured for the outermost flow with the following action chain: a rate limit action followed by a “created dynamic filter” action which creates a dynamic filter to limit TCP half-opens and with a filter qualifier tuple (DA) (i.e. one dynamic filter is created for each sub-flow with a unique destination encountered by the static filter for flow F0). Additional actions are permissible for the parent filter for flow F0 (for example, a log action 124 for the created filter action 122). The rate limiter action is typically configured prior to the “created dynamic filter” action as it prevents the creation mechanism from being over-whelmed by Denial of Service (DoS) attacks. In addition, a rate limit at 126 may be utilized for the first action for the filter rule 106. From the rate limit 126, a created filter action 128 may be implemented where the filter qualification is the SA, the action list is create a dynamic filter, IP stateful inspection, and a log and there is no metadata data. A limit TCP half-opens action 130 may then be implemented from the created dynamic filter action 128. A created dynamic filter action 132 may be implemented for the filter rule 108 where the filter qualifier is the (SP, DP) tuple (i.e. source and destination port), the action list is to conduct a TCP stateful inspection and the metadata data is the TCP state. An IP stateful inspection 134 may then be conducted from the created dynamic filter action 132. A log 136 may then be conducted. In addition, a TCP stateful inspection 138 is conducted for filter rule 110. The TCP half-open limiters in the parent flow F1 may require the TCP state of each TCP session and require this state. Additionally, a TCP stateful inspection 140 is conducted for filter rule 112. The dotted lines 150, 152, 154, and 156 indicate the created dynamic filter action that created the dynamic filter.

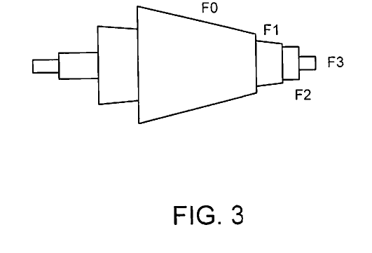

FIG. 3 is a simplified diagramming illustrating a resulting hierarchy of nested flows of the exemplary embodiment of the filtering system 10 of FIG. 2. The user creates a statically configured filter rule for the outermost flow (e.g., parent flow F0) within the filtering stage apparatus 12. If the packet 16 matches a filter (static or dynamic) and its action chain contains a created dynamic filter action, the routines utilized in the filtering stage apparatus 12 and associated with this action block create a new dynamic filter and install it in an free location above the current filter rule's position. The data-plane then proceeds to execute the action chain of the newly created dynamic filter before proceeding to execute the remaining actions in its action chain. Preferably, only one created dynamic filter action is allowed in the action chain for a given filter rule. When a packet matches any filter rule, it executes the action chain corresponding to that filter rule as well as the action chains of its parent flows. While executing a parent filter's action chain, the packet processing skips all action blocks prior to and up to the created dynamic filter action block in the parent filter. Thus, the created action block is not reentered again for the same sub-flow. The action chain of a filter may contain preliminary rate limit action blocks prior to the created dynamic filter action. These action blocks are executed only when the current filter rule is matched. Thus, these actions are skipped if the packet matches a child-flow filter rule. These actions may be used to rate limit and prevent overwhelming of the creation of dynamic filters. After executing the actions for a given matching filter rule, the state information may be propagated to the parent flows action blocks if required, thereby allowing the stateful inspection at multiple flow nesting levels. As shown in the example in FIG. 2, the innermost filters F3 and F3′ perform TCP stateful inspection. The state of the inner TCP session flows must be made available to the “limit TCP half-open” action belonging to the filter for flow F1 block which attempt to rate-limit TCP half-opens. It should be noted that flow F1 is higher in the hierarchy from F3 and F3′.

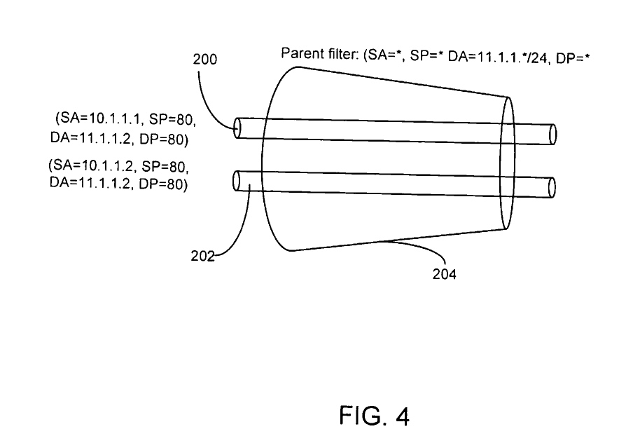

A created dynamic filter action (e.g., action 122 on FIG. 2) associated with a filter (static or dynamic) is used to create the dynamic filters. When the packet processing reaches this action, a new dynamic filter is installed and the action chain of the newly installed dynamic filter is executed before executing the remaining action blocks of the current filter. The created dynamic filter action must determine what the match conditions for the dynamic filter shall be. The match conditions are obvious for some stateful actions, such as “stateful inspection of a TCP session.” For example, in the filter rule 110 for F3, the action is stateful inspection of a TCP session. The match condition for the sub-flow dynamic filter is a specific tuple, i.e., (SA=10.1.1.1, SP=80, DA=11.1.1.1, DP=80). But for some stateful filters, the type of filter does not imply scope. FIG. 4 illustrates dynamic filters 200 and 202 within a parent filter 204 in an exemplary embodiment of the present invention. As illustrated in FIG. 4, if it is desired to rate limit the number of TCP half-open sessions arriving at a bank of servers, a static parent filter with match condition (SA=10.1.1.*/24, SP=*, DA=11.1.1/24, DP=*) may be sufficient. However, if an operator desires to apply this limit to each individual server in the bank of servers and the parent static filter is not sufficient, dynamic filters must be created with the specific server's address (e.g., 11.1.1.5 or 11.1.1.6) for which the TCP connection is destined. In such cases, the created dynamic filter action may require a new configuration object called a filter qualifier. The filter qualifier identifies the fields by which the new dynamic filters have to be created. When a packet is encountered which has a specific value in this field, then a dynamic filter with that specific value is created. In the above example, the filter qualifier is the DA. Thus, when traffic destined to (11.1.1.5) is encountered, the parent filter creates one dynamic filter for flow F1 with the match condition (SA=10.1.1.*/24, SP=*, DA=11.1.1.5, DP=*). It should be noted that the all other members, except the DA, remain the same as that of the parent flow. In addition, the DA is set to 11.1.1.5, indicating the scope of the sub-flow.

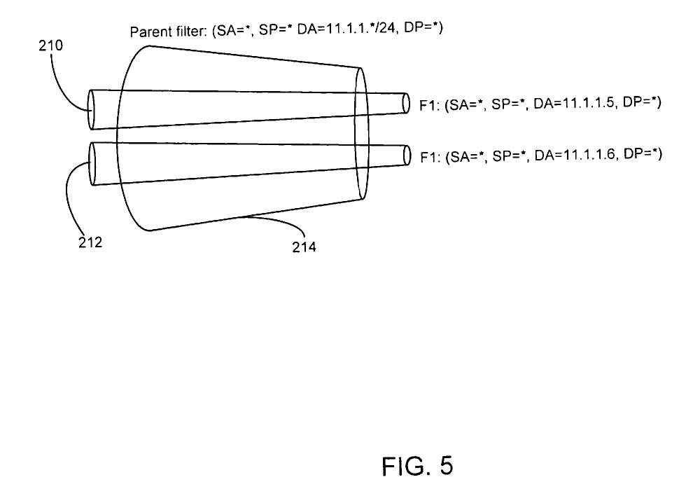

FIG. 5 illustrates dynamic filters 210 and 212 within a parent filter 214 in an exemplary embodiment. Similarly if another packet for a specific (DA=11.1.1.6) is encountered, another dynamic filter F1′ is created with a match condition of (SA=10.1.1/24, SP=*, DA=11.1.1.6, DP=*). The present invention automatically creates a filter for each specific destination address (sub-flow), but only when there exists traffic for that destination.

An ordered list of action identifiers, which specifies the action to be associated with the newly created dynamic filter, is provided (e.g., metering, half-open TCP counts, etc.). Furthermore, by including a created dynamic filter action in this action list, the newly created dynamic filter itself may create another more specific (i.e. narrowly scoped) dynamic filter. Thus, the present invention allows the creation of recursive dynamic filters to handle stateful inspection of nested flows.

In addition, a list of metadata, which must be supplied by the actions of subflows to the action blocks of their parent flows is provided. With the creation of nested dynamic filters, any or all of the stateful actions of a parent flow may depend on the state information from the sub-flows. Thus, an extension to traditional action chaining is provided in the present invention. Specifically, the state is propagated from a previous action in the chain (i.e. a sub-flow) as metadata to the next. The operator may specify the state to propagate when configuring a created dynamic filter action for a static policy rule. Once the dynamic filters are created, each dynamic filter maintains references to the filter representing its parent flow. The resultant chain of actions executed on a match is the combination of the action chain of the child flows and the action chain of the parent flows, barring the action that creates the dynamic filters.

To conserve system resources, the dynamically created filters that encompass multiple micro-flows may be removed if there is no significant activity for a specified period of time. To determine the activity level for each dynamically created filter, usage statistics may be maintained. In one embodiment, the “least recently used” or other qualification may be utilized to detect and remove inactive dynamically created filters. Expiration timers for a dynamically created filter may be initiated when there are no more filters associated with its sub-flows.

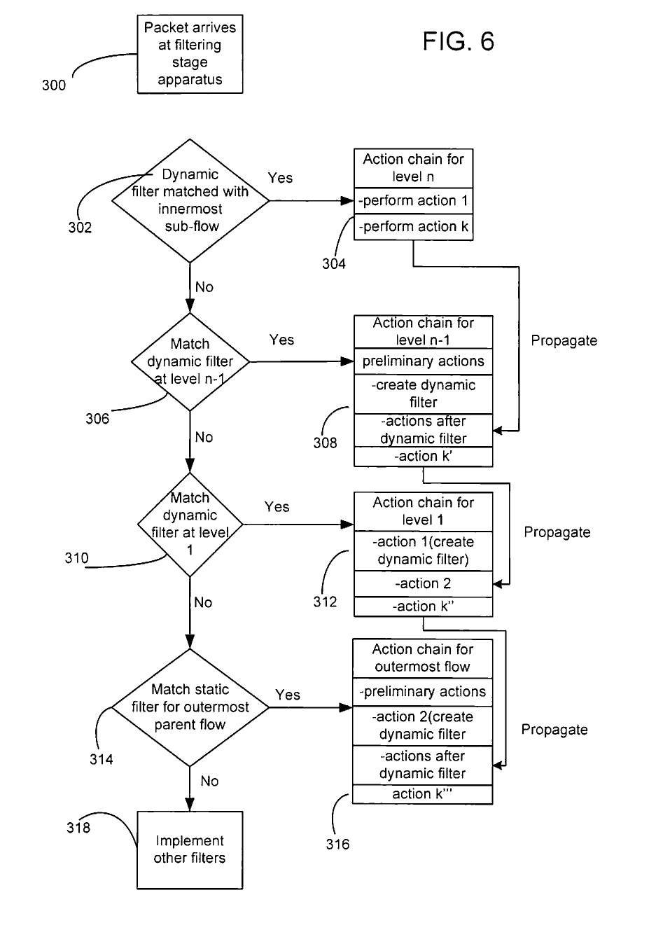

FIG. 6 is a flow chart outlining the steps for creating and managing recursive dynamic filters for stateful inspections of a hierarchy of nested flows with a corresponding action chain according to the teachings of the present invention. With reference to FIGS. 1-6, the methodology will now be explained. The method begins with step 300 where a packet 16 arrives at the filtering stage apparatus 12 of the firewall 14. Next, in step 302, the dynamic filter is matched with the innermost sub-flow (level n). If the packet matches the dynamic filter, the method moves to step 304 where an action chain for level n is accomplished. Specifically, action 1 through action k are performed. However, in step 302, if the packet does not match the dynamic filter, the method moves to step 306 where the packet is matched with the dynamic filter at the level n−1. If the packet matches the dynamic filter at level n−1, the method moves to step 308 where an action chain for level n−1 is accomplished. In this step 308, preliminary actions are accomplished and a created dynamic filter action is accomplished. The preliminary actions and the created dynamic filter actions are preferably executed only when the corresponding filter rule is matched. The preliminary actions may include simple rate limiters to ensure that the created dynamic filter actions are not overwhelmed with incoming traffic. If the action chain is being executed as part of a match of a narrower filter for an inner sub-flow, the preliminary actions are skipped. Thus, in step 304, after completion of the action k, the action is propagated to those actions taken after the created dynamic filter action in step 308. This prevents the recreation of the inner dynamic filter. Likewise, in step 308, after the creation of the dynamic filter, actions through action k′ are accomplished.

However, in step 306, if the packet 16 does not match the dynamic filter at level n−1, the method moves to step 310 where it is determined if the packet 16 matches the dynamic filter at level 1. If it is determined that the packet matches, the method moves from step 310 to step 312 where an action chain for level 1 is accomplished. Specifically, an action 1 (e.g., create a dynamic filter) through an action k′″ is accomplished. Referring back to step 308, after accomplishing action k″, the method is propagated to action 2 in step 312, thereby bypassing action 1 and the creation of a dynamic filter.

In step 308, if it is determined that the packet does not match the dynamic filter at level 1, the method moves to step 314 where the packet is matched with the static filter for the outermost parent flow. In step 314, if it is determined that the packet does match, the method moves to step 316 where an action chain for the outermost flow is accomplished. In this action chain, preliminary actions, an action 2 where a dynamic filter is created, actions after the creation of the dynamic filter, and action k′″ are accomplished. Referring back to step 312, after accomplishing action k″, the method is propagated to step 316 (skipping the preliminary actions).

In step 314, where it is determined that there is not a match of the packet 16 with the static filter for the outermost parent flow, the method then moves to step 318 where other filters, if present, are implemented. An action chain corresponding to a filter rule may have a maximum of one created dynamic filter action. The example in FIG. 6 illustrates an exemplary implementation of the filtering system 10.

The present invention is an efficient scaleable apparatus and methodology for filtering and implementing stateful inspections of a hierarchy of nested flows. The present invention does not require the creation of statically configured filters for all the subflows apriori or the use of multiple filtering stages. The dynamically created filters for sub-flows are only created if traffic for such sub-flows are encountered at the router or firewall. If there is no traffic present, filters are not created and resources in the data-plane classification stage are conserved. The present invention is applicable to point-to-point, multi-point-to-point, point-to-multi-point and multi-point-to multi-point flows which may be nested hierarchically in other such flows. The present invention is not limited to layer 3 and layer 4 UDPITCP/IP addressing fields. The present invention may be extended to other fields in other layers as well.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates all modifications that fall within the scope of the invention defined by the following claims.

What is claimed is:

1. A method of creating and managing dynamic filters for packets flowing in a forwarding data-plane, the method comprising the steps of:
determining if a packet flowing in the forwarding data-plane matches a first filter rule;
upon determining that the packet matches the first filter rule;
creating a first dynamic filter; and
executing an action associated with the first dynamic filter.

2. The method of creating and managing dynamic filters of claim 1 wherein the step of determining if a packet flowing in the forwarding data-plane matches a first filter rule includes determining if a tuple of the packet matches a specific tuple.

3. The method of creating and managing dynamic filters of claim 1 wherein the step of determining if a packet flowing in the forwarding data-plane matches a first filter rule includes determining if a source address of the packet matches a specified source address.

4. The method of creating and managing dynamic filters of claim 1 wherein the step of determining if a packet flowing in the forwarding data-plane matches a first filter rule includes determining if a destination address of the packet matches a specified destination address.

5. The method of creating and managing dynamic filters of claim 1 wherein the step of determining if a packet flowing in the forwarding data-plane matches a first filter rule includes determining if a destination port of the packet matches a specified destination port.

6. The method of creating and managing dynamic filters of claim 1 wherein the step of determining if a packet flowing in the forwarding data-plane matches a first filter rule includes determining if a filter qualifier of the packet matches a specified filter qualifier.

7. The method of creating and managing dynamic filters of claim 1 wherein the packet is transported within a parent flow.

8. The method of creating and managing dynamic filters of claim 7 wherein the packet is transported within a first sub-flow associated with the first dynamic filter.

9. The method of creating and managing dynamic filters of claim 1 further comprising the steps of:
determining if the packet flowing in the forwarding data-plane matches a second filter rule;
upon determining that the packet matches the second filter rule;
creating a second dynamic filter; and
executing an action associated with the second dynamic filter.

10. The method of creating and managing dynamic filters of claim 9 further comprising the step of executing a preliminary action associated with the second filter rule prior to creating a second dynamic filter.

11. The method of creating and managing dynamic filters of claim 10 wherein the step of creating a second dynamic filter includes creating the second dynamic filter without performing any preliminary action associated with the second filter rule.

12. The method of creating and managing dynamic filters of claim 10 wherein the preliminary action includes rate limiting the flow of packets.

13. The method of creating and managing dynamic filters of claim 10 wherein the step of executing an action associated with the second dynamic filter includes performing an Internet Protocol (IP) stateful inspection.

14. The method of creating and managing dynamic filters of claim 10 wherein the step of executing an action associated with the second dynamic filter includes creating a third dynamic filter.

15. The method of creating and managing dynamic filters of claim 9 further comprises the step of propagating a state from the action associated with the first dynamic filter as metadata in the action associated with the second dynamic filter.

16. An apparatus for creating and managing dynamic filters for packets flowing in a forwarding data-plane, the apparatus comprising:
means for determining if a packet matches a first filter rule;
means for creating a first dynamic filter; and
means for executing an action associated with the first dynamic filter.

17. The apparatus for creating and managing dynamic filters of claim 16 wherein the apparatus resides within a router.

18. The apparatus for creating and managing dynamic filters of claim 16 wherein the apparatus resides within a firewall.

19. The apparatus for creating and managing dynamic filters of claim 16 wherein the means for determining if a packet matches a first filter rule includes means for matching a filter qualifier of the packet with specified filter qualifier.

20. The apparatus for creating and managing dynamic filters of claim 16 further comprising:
means for determining if the packet matches a second filter rule;
means for creating a second dynamic filter; and
means for executing an action associated with the second dynamic filter.

21. The apparatus for creating and managing dynamic filters of claim 20 wherein a preliminary action associated with the second filter rule is executed prior to creating the second dynamic filter.

22. The apparatus for creating and managing dynamic filters of claim 20 further comprising means for executing an action associated with a second dynamic filter without creating the second dynamic filter.

23. The apparatus for creating and managing dynamic filters of claim 16 further comprising means for performing an Internet Protocol (IP) stateful inspection of a flow of packets.
